(19) United States
(12) Patent Application Publication
(10) Pub. No.: US 2024/0216849 A1
(43) Pub. Date: Jul. 4, 2024

(54) FILTER ELEMENT AND FILTER SYSTEM

(71) Applicant: MANN+HUMMEL GmbH, Ludwigsburg (DE)

(72) Inventor: Daniel SCHMID, Sachsenheim (DE)

(21) Appl. No.: 18/604,693

(22) Filed: Mar. 14, 2024

Related U.S. Application Data
(63) Continuation of application No. PCT/EP2022/072786, filed on Aug. 15, 2022.

(30) Foreign Application Priority Data
Sep. 17, 2021 (DE) 102021124080.8

(51) Int. Cl. B01D 46/52; B01D 46/00

(52) U.S. Cl. CPC B01D 46/521; B01D 46/0002; B01D 2271/022; B01D 2279/60

(57) ABSTRACT

A filter element for filtering a fluid has a zigzag-shaped filter bellows with folds having parallel fold tips successively arranged in length extension of the filter bellows transverse to a vertical axis of the filter bellows. The fold tips extend between longitudinal sides of the filter bellows which are parallel to the length extension. The filter bellows is arranged in a continuous frame and surrounded by the continuous frame. The continuous frame has at least one first frame segment and at least one second frame segment, wherein the first frame segment has a hardness different from a hardness of the second frame segment. The first frame segment is formed of a first hard material and the second frame segment is formed of a second soft material. The filter bellows is fixed in the second frame segment. A filter system has such a filter element arranged in a filter housing.

### CROSS-REFERENCE TO RELATED APPLICATIONS

This application is a continuation application of international application No. PCT/EP2022/072786 having an international filing date of 15 Aug. 2022 and designating the United States, the international application claiming a priority date of 17 Sep. 2021 based on prior filed German patent application No. 10 2021 124 080.8, the entire contents of the aforesaid international application and the aforesaid German patent application being incorporated herein by reference.

### BACKGROUND OF THE INVENTION

The invention concerns a filter element for filtering a fluid, in particular air, in particular for use as an intake air filter in an internal combustion engine, in particular of a motor vehicle. Further uses are also possible, for example, as interior air filter, in particular of a motor vehicle, or as a filter element in a vacuum cleaner. Furthermore, the invention concerns a filter system with a filter element.

In filter elements overmolded by plastic material, the filter bellows is generally completely overmolded with a material, for example, plastic material or a thermoplastic elastomer (TPE). When the filter element is overmolded with a hard plastic material, for example, polyamide (PA) or polypropylene (PP), a soft seal material as a seal material is either molded on by 2K injection molding or joined as a separate component by form fit. Alternatively, the seal can also be provided in the counterpart component in which the filter element is installed.

DE 10 2018 116 098 A1 proposes a method for producing a filter element for filtering a fluid in which, between a filter medium and a frame device surrounding the filter medium, a curable connection material is introduced in an uncured state, wherein the uncured connection material is kept in shape at least partially by means of a casting mold.

DE 10 2015 011 339 A1 proposes a filter element for filtering a fluid, in particular for use as an interior air filter, in particular of a motor vehicle, which comprises at least one substantially cuboid filter body, in particular filter bellows with an intended raw-side end face and an intended clean-side end face positioned opposite thereto as well as with oppositely positioned side faces. Furthermore, the filter element comprises a filter frame which encloses the filter bellows at the side faces circumferentially and which comprises at least two frame parts as well as a seal which encloses circumferentially an edge between one of the end faces of the filter bellows and the side faces. In this context, the seal connects the at least two frame parts and the filter body, in particular filter bellows, with friction fit and/or form fit.

EP 0 721 792 A1 discloses a filter element with a hard frame element around which a seal and support element of a softer material is arranged.

### SUMMARY OF THE INVENTION

It is an object of the invention to provide a filter element with at least one filter bellows which can be cleaned better.

A further object is providing a filter system with such a filter element.

The aforementioned object is solved according to an aspect of the invention by a filter element for filtering a fluid with at least one filter bellows folded in a zigzag shape to folds, with parallel fold tips successively arranged in a length extension transverse to a vertical axis of the filter bellows and extending respectively between longitudinal sides of the filter bellows arranged parallel to the length extension, wherein the filter bellows is arranged so as to be surrounded in a continuous frame, wherein the surrounding frame comprises at least a first and at least a second frame segment with different hardness, wherein the first frame segment is formed of a first hard material, in particular of a hard plastic material, and the second frame segment is formed of a second soft material, in particular of a soft plastic material, wherein the filter bellows is fixed in the second frame segment, in particular is overmolded at least in sections.

The further object is solved according to a further aspect of the invention by a filter system for filtering a fluid with a filter housing and a filter element for filtering a fluid, in particular according to one of the preceding claims, arranged exchangeably in the filter housing between a raw side and a clean side, with at least one filter bellows folded in a zigzag shape to folds, with parallel fold tips successively arranged in a length extension transverse to a vertical axis of the filter bellows and extending respectively between longitudinal sides of the filter bellows arranged parallel to the length extension, wherein the filter bellows is arranged so as to be surrounded in a continuous frame, wherein the surrounding frame comprises at least a first and at least a second frame segment with different hardness, wherein the first frame segment is formed of a first hard material, in particular of a hard plastic material, and the second frame segment is formed of a second soft material, in particular of a soft plastic material, wherein the filter bellows is fixed in the second frame segment, in particular is overmolded at least in sections.

Beneficial embodiments and advantages of the invention result from the further claims, the description, and the drawing.

A filter element for filtering a fluid is proposed with at least one filter bellows which is folded in a zigzag shape to folds, with parallel fold tips successively arranged in a length extension transverse to a vertical axis of the filter bellows and extending respectively between longitudinal sides of the filter bellows arranged parallel to the length extension. The filter bellows is arranged so as to be surrounded in a continuous frame, wherein the surrounding frame comprises at least a first and at least a second frame segment with different hardness. The first frame segment is formed of a first material, in particular of a hard plastic material, and the second frame segment is formed of a second material, in particular of a soft plastic material. In this context, the filter bellows is fixed in the second frame segment, in particular overmolded at least in sections.

In the proposed filter element, the surrounding frame in which the filter bellows is arranged is divided into two frame segments, namely into a soft and a hard component. The interface to a seal for separating the raw side and the clean side is realized of a hard plastic material in this context. The part of the frame which surrounds the folds of the filter bellows is produced from a soft material, for example, TPE. Due to the soft frame material of the second frame segment, the folds of the folded filter medium of the filter bellows remain flexible which is beneficial in respect to cleaning of the filter bellows in case of heavy soiling. The hard first frame segment is embodied to extend circumferentially and forms in this context a robust interface for the seal which either can be attached directly to the hard first frame segment or is seated in the counterpart component in which the filter element is installed.

Due to the flexible configuration of the frame in the region of the folds of the filter bellows, a movability of the folds is achieved. The movability of the folds leads to an improved cleaning behavior. In this context, cleaning can be done, for example, manually by beating or by a mechanism which causes the filter element to vibrate. Also, it is prevented that in case of short-term high mechanical loads, for example, a high dust load of the filter bellows, the folds in the frame will be damaged or even become detached from the frame. In the proposed filter element, the folds as well as the frame can yield elastically.

The hard frame segment of the frame in direction toward the clean side of the filter system is advantageous when the seal is arranged in the filter housing and not at the filter element itself. Also, additional functions, for example, a snap hook for attachment of the filter element in the filter housing, can be integrated in the hard plastic frame.

The filter element can comprise a rectangular cross section with two parallel extending, oppositely positioned longitudinal sides and two oppositely positioned, parallel extending transverse sides. However, other shapes are also conceivable, for example, with angularly extending sides. Longitudinal sides are to be understood as the sides which comprise the open end face edges of the folds while the transverse sides comprise the end edges of the filter bellows.

Advantageously, the filter bellows which is formed in particular as a flat filter can be manufactured as one piece or one part. The filter bellows, for example, can be formed of a nonwoven and/or cellulose as filter medium.

The first material of the first frame segment can be, for example, a hard plastic material such as polyamide (PA) or polypropylene (PP). The second material of the second frame segment can be comprised of, for example, a thermoplastic elastomer (TPE). The combination of PA or PP and TPE leads to a high mechanical and thermal resistance of the frame. In particular in comparison to a conventional frame of PUR (polyurethane), a durable and robust element can be provided in this way.

According to an advantageous embodiment of the filter element, the second frame segment can be embodied at least at the oppositely positioned longitudinal sides of the filter bellows. In this embodiment, the second frame segment is not formed circumferentially like the first frame segment but covers, for example, only the two longitudinal sides of the filter bellows so that the longitudinal sides of the filter bellows are sealed and, thus, the raw side of the filter element is sealed in relation to the clean side.

According to an advantageous embodiment of the filter element, at least the longitudinal sides of the filter bellows can be overmolded with the second material of the second frame segment. In this way, the longitudinal sides of the filter bellows can be sealed in a beneficial way. Thus, the raw side of the filter element is sealed in relation to the clean side.

According to an advantageous embodiment of the filter element, fold tips between the folds can be filled with the second material of the second frame segment at the longitudinal sides. In this manner, the filter bellows can be sealed very reliably at its longitudinal sides.

According to an advantageous embodiment of the filter element, the frame with the first and the second frame segment can be produced in a 2K injection molding process. With such a manufacturing process, a filter element as proposed can be produced in a particularly inexpensive way. At the same time, a good adhesion behavior of the two frame segments at each other can be achieved.

According to an advantageous embodiment of the filter element, at least one reinforcement element in which folds of the filter bellows are fixed can be provided along the length extension of the filter bellows between two oppositely positioned transverse sides of the frame. In particular, in this context the folds can be overmolded with the second material as reinforcement element. In this context, the reinforcement element itself is formed by casting or injection molding of the second material. In this manner, the filter bellows, in particular when the filter bellows is very large with regard to surface area, can be effectively stabilized against high pressure due to high dust loads. Due to overmolding of the folds with the second material, a particularly good adhesion behavior can be achieved. At the same time, the filter bellows still exhibits the required flexibility for beneficial cleaning in case of high dirt load.

According to an advantageous embodiment of the filter element, fold tips between the folds can be filled with the second material of the second frame segment in the region of the reinforcement element. A beneficial and permanently reliable connection of the filter bellows to the reinforcement element can be achieved due to filling of the fold tips.

According to an advantageous embodiment of the filter element, the at least one reinforcement element can be formed as one piece together with the second frame segment. Particularly when the second frame segment is embodied to extend circumferentially, the reinforcement element can be formed beneficially as one piece together with the second frame segment. In this way, the filter element can be produced particularly inexpensively.

According to an advantageous embodiment of the filter element, end face end edges of the filter bellows at the transverse sides of the frame can be arranged in the second frame segment. In particular, the end edges can be overmolded with the second material in this context. In this way, the folds of the filter bellows can be joined particularly effectively to the frame. At the same time, the filter bellows can be effectively sealed in this manner at the transverse sides so that raw side and clean side of the filter element are sealed relative to each other.

According to an advantageous embodiment of the filter element, the frame can comprise a seal circumferentially extending at a first flat side. In this manner, raw side and clean side of the filter element can be sealed effectively relative to each other upon installation of the filter element in a housing of a filter system. The seal can be comprised of a conventional seal material, for example, ethylene propylene diene (monomer) rubber (EPDM), or a PUR foam.

According to an advantageous embodiment of the filter element, the seal can be foamed on. In this way, a reliable connection of the seal at the frame can be achieved. In addition, the seal is arranged captively at the filter element in the mounting process and during the installation process in the filter system.

According to an advantageous embodiment of the filter element, the seal can be produced in a 2K process together with the frame. In such a process, the seal can be produced particularly inexpensively. Furthermore, a reliable connection of the seal to the frame can be achieved. In addition, the seal is arranged captively at the filter element in the mounting process and during the installation process in the filter system.

According to an advantageous embodiment of the filter element, the first frame segment can be embedded in the second frame segment. In particular, in this context the first frame segment can be overmolded with the material of the second frame segment at an outwardly circumferentially extending outer edge. Due to the second material of the second frame segment which is embodied softer than the first material of the first frame segment, a flexible arrangement of the filter element in the housing of a filter system can be achieved. In addition, the soft second material can fulfill additionally a sealing function upon installation in the housing.

According to a further aspect of the invention, a filter system for filtering a fluid is proposed, with a filter housing and a filter element for filtering a fluid exchangeably arranged in the filter housing between a raw side and a clean side, with at least one filter bellows which is folded in a zigzag shape to folds, with parallel fold tips successively arranged in a length extension transverse to a vertical axis of the filter bellows and extending respectively between longitudinal sides of the filter bellows extending parallel to the length extension. The filter bellows is arranged so as to be surrounded in a continuous frame, wherein the surrounding frame comprises at least a first and at least a second frame segment with different hardness. The first frame segment is formed of a first material, in particular of a hard plastic material, and the second frame segment is formed of a second material, in particular of a soft plastic material. In this context, the filter bellows is fixed in the second frame segment, in particular overmolded at least in sections.

In the filter element, the surrounding frame in which the filter bellows is arranged is divided into two frame segments, namely into a soft and a hard component. The interface to a seal is realized in this context of a hard plastic material. The part of the frame which surrounds the folds of the filter bellows is produced of a soft material, for example TPE. Due to the soft frame material of the second frame segment, the folds of the folded filter bellows remain flexible which is beneficial for cleaning of the filter bellows in case of heavy soiling. The hard first frame segment forms in this context a robust interface for the seal which can be attached either directly to the hard first frame segment or is seated in the counterpart component into which the filter element is installed.

Due to the flexible configuration of the frame in the region of the folds of the filter bellows, a movability of the folds is achieved. The movability of the folds leads to a better cleaning behavior. Furthermore, it is prevented that, in case of short-term high mechanical loads, the folds in the frame become damaged or even become detached from the frame. In the proposed filter element, the folds as well as the frame can yield elastically.

The hard frame segment of the frame in direction toward the clean side of the filter system is advantageous when the seal is arranged in the filter housing and not at the filter element itself. Also, additional functions, for example, a snap hook for attachment of the filter element in the filter housing, can be integrated in the hard plastic frame.

Advantageously, the filter bellows which is formed in particular as a flat filter can be manufactured as one piece or as one part. The filter bellows can be formed, for example, of a nonwoven and/or cellulose as filter medium.

The first material of the first frame segment can be, for example, a hard plastic material such as polyamide (PA) or polypropylene (PP). The second material of the second frame segment can be advantageously comprised of a thermoplastic elastomer (TPE). A frame of this material combination has a high thermal and mechanical resistance.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows an isometric illustration of a filter element with a filter bellows according to an embodiment of the invention.

FIG. 2 shows a plan view of the filter element according to FIG. 1 with two indicated section planes A-A, B-B.

FIG. 3 shows a longitudinal section through the filter element along the section plane A-A according to FIG. 2.

FIG. 4 shows a cross section through the filter element along the section plane B-B according to FIG. 2.

FIG. 5 shows an isometric illustration of a filter element with a seal arranged circumferentially at the frame according to a further embodiment of the invention.

FIG. 6 shows a plan view of the filter element according to FIG. 5 with two indicated section planes A-A, B-B.

FIG. 7 shows a longitudinal section through the filter element along the section plane A-A according to FIG. 6.

FIG. 8 shows a cross section through the filter element along the section plane B-B according to FIG. 6.

FIG. 9 shows a longitudinal section through a filter system with installed filter element according to an embodiment of the invention.

### DESCRIPTION OF PREFERRED EMBODIMENTS

In the Figures, same or same-type components are identified with same reference characters. The Figures show only examples and are not to be understood as limiting.

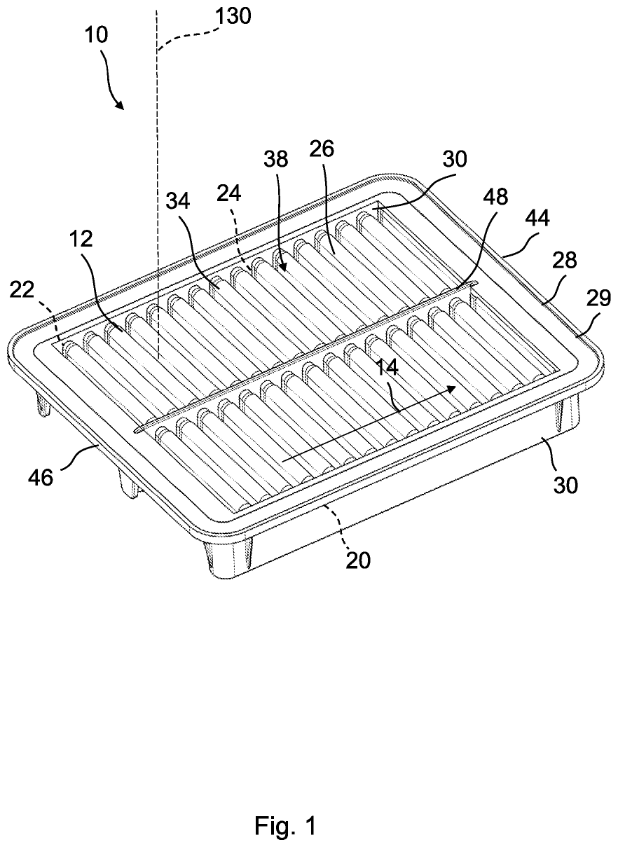

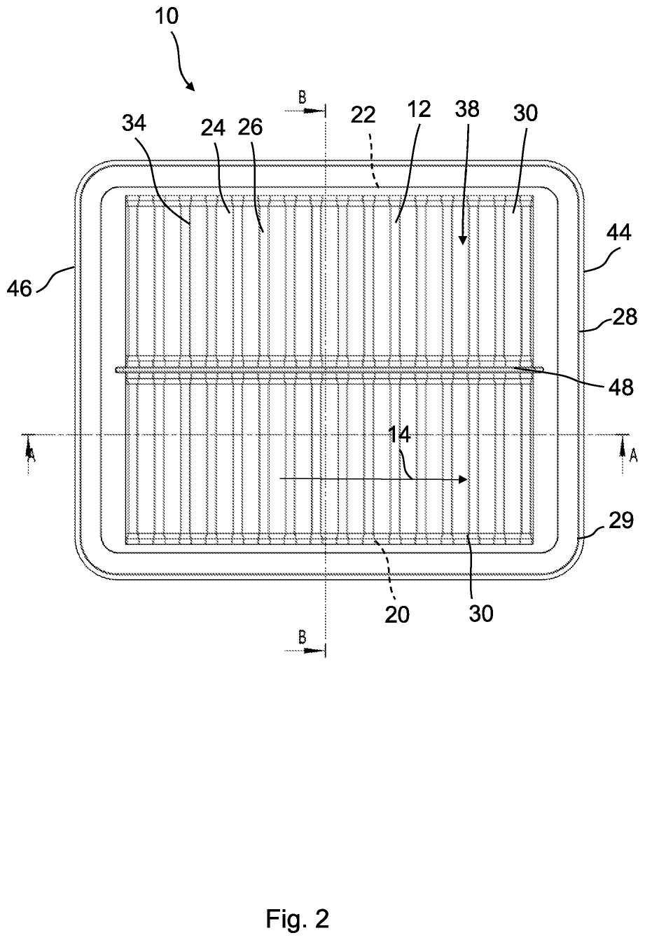

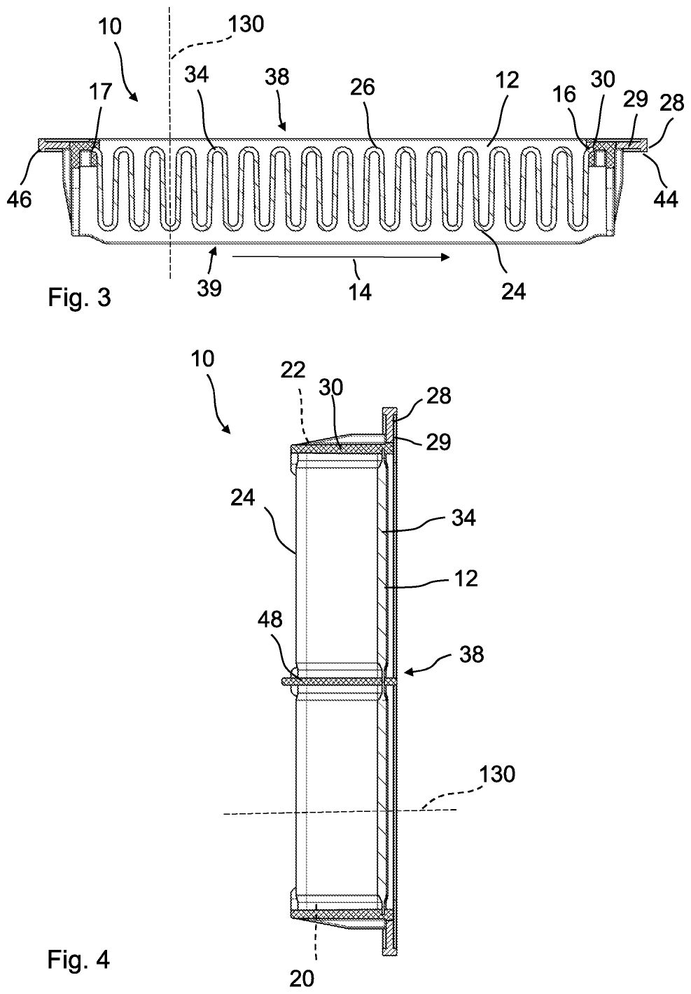

FIG. 1 shows an isometric illustration of a filter element 10 with a filter bellows 12 according to an embodiment of the invention. FIG. 2 shows a plan view of the filter element 10 with two indicated section planes A-A, B-B. In this context, FIG. 3 shows a longitudinal section through the filter element 10 along the section plane A-A and FIG. 4 a cross section through the filter element 10 along the section plane B-B.

The filter element 10 for filtering a fluid comprises a filter bellows 12 which is folded in a zigzag shape to folds 34 with parallel fold tips 24, 26 successively arranged in a length extension 14 transverse to a vertical axis 130 of the filter bellows 12. The fold tips 24, 26 extend respectively between longitudinal sides 20, 22 of the filter bellows 12 arranged parallel to the length extension 14.

The fold tips 26 form in this context a first flat side 38 of the filter bellows 12 while the oppositely positioned fold tips 24 form the second flat side 39 of the filter bellows 12.

The filter bellows 12 is arranged so as to be surrounded in a continuous frame 28. The surrounding frame 28 comprises a first and a second surrounding frame segment 29, 30 with different hardness. In this context, the first frame segment 29 is formed of a first material in the form of a hard plastic material, in particular PA or PP, and the second frame segment 30 is formed of a second material in the form of a soft plastic material, in particular TPE. The filter bellows 12 is fixed in the second frame segment 30 of the softer material. In particular, the filter bellows 12 can be overmolded at least in sections. The filter bellows 12 is in particular formed as one piece and/or as one part.

In the intended operation of the filter element 10, inflow of the fluid to be filtered at the filter bellows 12 is from the second flat side 39 (see FIG. 3); the fluid exits again from the filter bellows 12 from the first flat side 38. The second flat side 39 forms thus the inflow side and the first flat side 38 the outflow side.

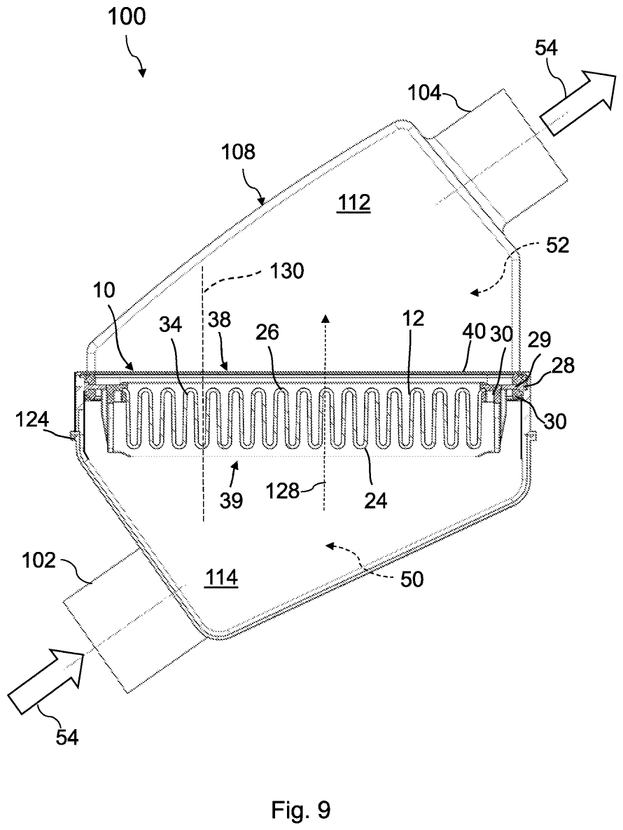

In this context, the second frame segment 30 is formed at least at the oppositely positioned longitudinal sides 20, 22 of the filter bellows 12. Expediently, for this purpose the longitudinal sides 20, 22 of the filter bellows 12 are overmolded with the second material of the second frame segment 30 so that, at the longitudinal sides 20, 22, the fold tips 24, 26 between the folds 34 are filled with the second material of the second frame segment 30. In this way, a particularly beneficial sealing action between raw side 50 and clean side 52 of the filter element 10 is achieved, which can be seen in particular in the illustration of the filter element 10 installed in the filter housing 108 in FIG. 9.

The frame 28 with the first and the second frame segment 29, 30 can be produced beneficially in a 2K injection molding process.

Between two oppositely positioned transverse sides 44, 46 of the frame 28, a reinforcement element 48 is provided along the length extension 14 of the filter bellows 12 in which folds 34 of the filter bellows 12 are fixed. In particular, the folds 34 can be overmolded with the second material as reinforcement element 48 so that the fold tips 24 between the folds 34 are filled with the second material of the second frame segment 30. In this way, a particularly beneficial and permanent connection of the filter bellows 12 to the reinforcement element 48 is achieved.

The reinforcement element 48 can be formed expediently together with the second frame segment 30 as one piece.

As can be seen in particular in the longitudinal section in FIG. 3, the end face end edges 16, 17 of the filter bellows 12 at the transverse sides 44, 46 of the frame 28 are arranged in the second frame segment 30. In particular, the end edges 16, 17 can be overmolded with the second material in this context in order to achieve a connection of the end edges 16, 17 of the filter bellows 12 as good as possible to the second frame segment 30.

In the cross section in FIG. 4 it can be seen in particular that the second frame segment 30 is formed at the longitudinal sides 20, 22 of the filter bellows 12 across their entire height along the vertical axis 130. In this way, a sufficient sealing action of the filter bellows 12 at the longitudinal sides 20, 22 can be achieved.

Likewise, it can be seen that the reinforcement element 48 is formed also across the full height of the folds 34 along the vertical axis 130. In this way, a sufficient stabilization of the filter bellows 12 against vibrations can be achieved.

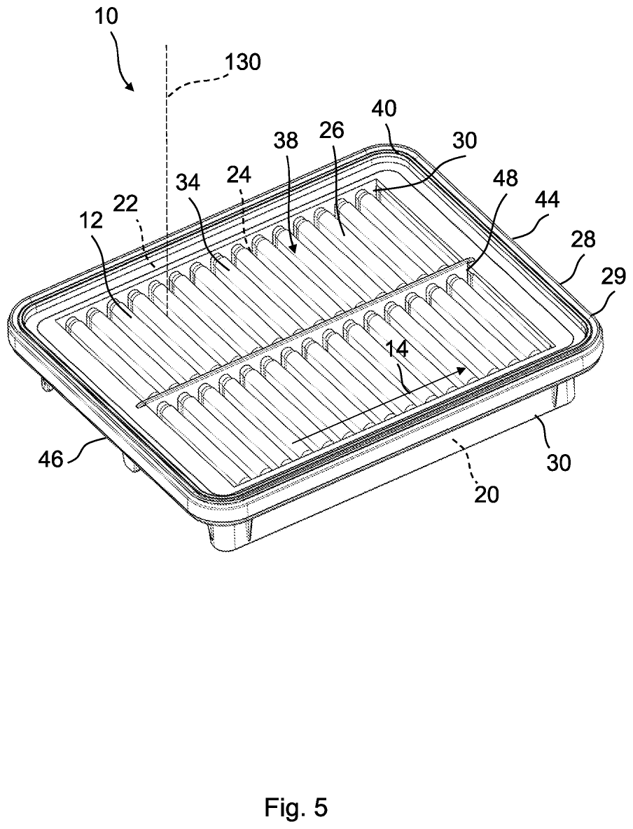

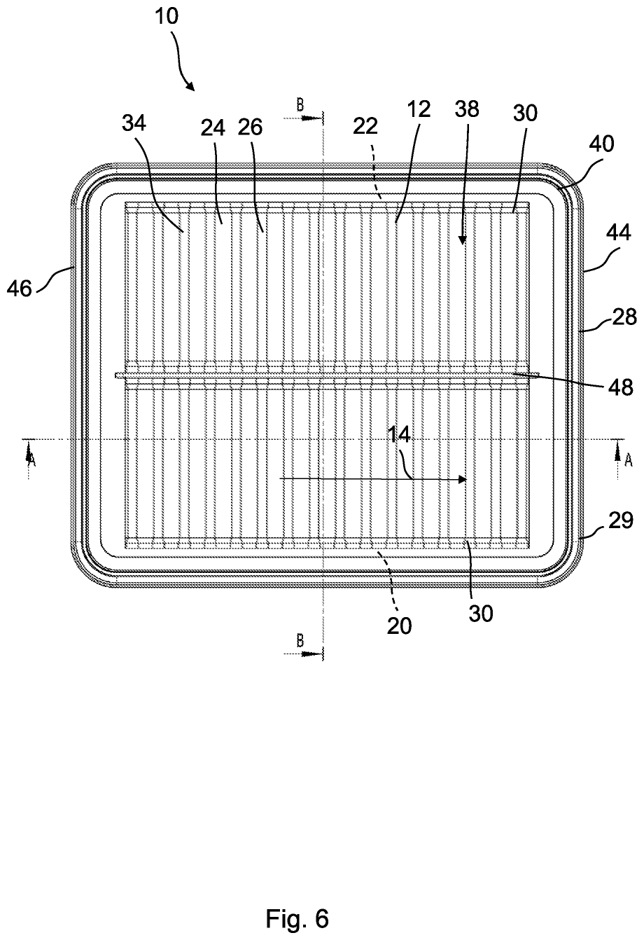

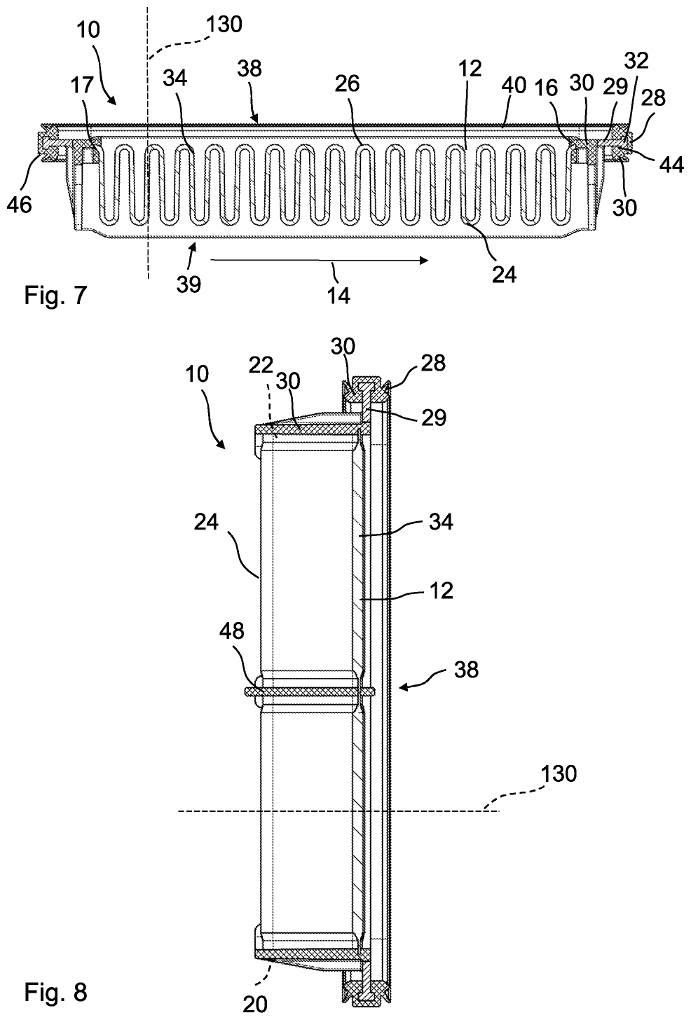

FIG. 5 shows an isometric illustration of a filter element 10 with a seal 40 arranged circumferentially on the frame according to a further embodiment of the invention. In FIG. 6, a plan view of the filter element 10 is illustrated with two indicated section planes A-A, B-B. FIG. 7 shows in this context a longitudinal section through the filter element 10 along the section plane A-A while in FIG. 8 a cross section through the filter element 10 along the section plane B-B is illustrated.

In the embodiment illustrated in FIGS. 5 to 8, the frame 28 of the filter element 10 comprises in addition a seal 40 circumferentially extending at the first flat side 38 which serves for sealing the raw side 50 of the filter element 10 against the clean side 52 upon installation of the filter element 10 in a filter housing 108, as illustrated in FIG. 9.

The seal 40 is applied to an end face of the first frame segment 29 of the frame 28 which is oriented parallel to the first flat side 38 of the filter bellows 12.

The seal 40 can be foamed, for example, onto the frame 28. Beneficially, the seal 40 can also be produced in a 2K process together with the frame 28.

Furthermore, in particular in the sections in FIGS. 7 and 8 it can be seen that the first frame segment 29 is embedded in the second frame segment 30. In particular, the first frame segment 29 in this context is overmolded at an outwardly circumferentially extending outer edge 32 with the material of the second frame segment 30.

By means of the second material of the second frame segment 30 which is softer than the first material of the first frame segment 29, a vibration-protected arrangement of the filter element 10 in the housing 108 of a filter system 100, in particular in a lateral direction perpendicular to the vertical axis 130 of the filter element 10, can be achieved. Furthermore, the soft second material can fulfill in addition a sealing function upon installation in the housing 108.

FIG. 9 shows a longitudinal section through a filter system 100 with installed filter element 10 according to an embodiment of the invention.

The filter system 100 for filtering a fluid comprises a filter housing 108 and a filter element 10 for filtering a fluid which is arranged exchangeably in the filter housing 108 between a raw side 50 and a clean side 52.

The filter housing 108 comprises a housing bottom part 114 with an inlet 102 for the fluid to be filtered as well as a housing top part 112 with an outlet 104. The flow direction 54 of the fluid is identified by arrows.

After installation of the filter element 10, the two housing parts 112, 114 can be joined along a joining region 124, for example, by a clip connection. The filter element 10 is arranged in the interior of the filter housing 108 and separates the raw side 50 from the clean side 52. The main flow axis 128 of the fluid through the filter element 10 extends parallel to the vertical axis 130 of the filter element 10.

The filter element 10 for filtering a fluid comprises a filter bellows 12 which is folded in a zigzag shape to folds 34 with parallel fold tips 24, 26 successively arranged in a length extension 14 transverse to a vertical axis 130 of the filter bellows 12. The fold tips 24, 26 extend respectively between longitudinal sides 20, 22 of the filter bellows 12 arranged parallel to the length extension 14.

The filter bellows 12 is arranged so as to be surrounded in a continuous frame 28. The surrounding frame 28 comprises a first and a second frame segment 29, 30 with different hardness. In this context, the first frame segment 29 is formed of a first material in the form of a hard plastic material, in particular PA or PP, and the second frame segment 30 is formed of a second material in the form of a soft plastic material, in particular TPE. The filter bellows 12 is fixed in the second frame segment 30. In particular, the filter bellows 12 can be overmolded at least in sections. The filter bellows 12 is in particular embodied as one piece and/or as one part.

### REFERENCE CHARACTERS

10 filter element
12 filter bellows
14 length extension
16 end edge
17 end edge
20 longitudinal side
22 longitudinal side
24 fold tip
26 fold tip
28 frame
29 frame segment
30 frame segment
32 outer edge
34 fold
38 flat side
39 flat side
40 seal
44 transverse side
46 transverse side
48 reinforcement element
50 raw side
52 clean side
54 flow direction
100 filter system
102 inlet
104 outlet
108 filter housing
112 housing top part
114 housing bottom part
124 joining region
128 main flow axis
130 vertical axis

What is claimed is:

1. A filter element for filtering a fluid, the filter element comprising:
at least one filter bellows folded in a zigzag shape to folds, wherein the folds comprise parallel fold tips successively arranged in a length extension of the at least one filter bellows transverse to a vertical axis of the at least one filter bellows, wherein the parallel fold tips extend respectively between longitudinal sides of the at least one filter bellows, wherein the longitudinal sides are arranged parallel to the length extension;
a continuous frame, wherein the at least one filter bellows is arranged in the continuous frame so as to be surrounded by the continuous frame;
wherein the continuous frame comprises at least one first frame segment and at least one second frame segment, wherein the at least one first frame segment has a hardness different from a hardness of the at least one second frame segment, wherein the at least one first frame segment is formed of a first hard material and the at least one second frame segment is formed of a second soft material;
wherein the at least one filter bellows is fixed in the at least one second frame segment.

2. The filter element according to claim 1, wherein the at least one filter bellows is fixed in the at least one second frame segment by overmolding at least in sections.

3. The filter element according to claim 1, wherein the first hard material is a hard plastic material and wherein the second soft material is a soft plastic material.

4. The filter element according to claim 1, wherein the at least one second frame segment is arranged at least at the longitudinal sides of the at least one filter bellows positioned opposite each other.

5. The filter element according to claim 4, wherein at least the longitudinal sides of the at least one filter bellows are overmolded with the second soft material.

6. The filter element according to claim 5, wherein the parallel fold tips between the folds are filled with the second soft material at the longitudinal sides of the at least one filter bellows.

7. The filter element according to claim 1, wherein the continuous frame together with the at least one first frame segment and the at least one second frame segment is produced in a 2K injection molding process.

8. The filter element according to claim 1, further comprising at least one reinforcement element configured to fix the folds of the at least one filter bellows, wherein the at least one reinforcement extends along the length extension of the at least one filter bellows between two oppositely positioned transverse sides of the continuous frame.

9. The filter element according to claim 8, wherein the folds are overmolded with the second soft material to form the at least one reinforcement element.

10. The filter element according to claim 8, wherein the parallel fold tips between the folds are filled with the second soft material forming the at least one reinforcement element.

11. The filter element according to claim 8, wherein the at least one reinforcement element is formed as one piece together with the at least one second frame segment.

12. The filter element according to claim 1, wherein the at least one filter bellows comprises end face end edges disposed at transverse sides of the continuous frame, wherein the end face end edges are arranged in the at least one second frame segment.

13. The filter element according to claim 12, wherein the end face end edges are overmolded with the second soft material.

14. The filter element according to claim 1, wherein the continuous frame comprises a seal circumferentially extending around a flat side of the at least one filter bellows.

15. The filter element according to claim 14, wherein the seal is foamed onto the continuous frame.

16. The filter element according to claim 14, wherein the seal is produced in a 2K process together with the continuous frame.

17. The filter element according to claim 1, wherein the at least one first frame segment is embedded in the at least one second frame segment.

18. The filter element according to claim 17, wherein the at least one first frame segment is overmolded at an outwardly circumferentially extending outer edge thereof with the second soft material of the at least one second frame segment.

19. A filter system comprising:
a filter housing;
a filter element for filtering a fluid exchangeably arranged in the filter housing between a raw side and a clean side of the filter housing;
wherein the filter element comprises at least one filter bellows folded in a zigzag shape to folds, wherein the folds comprise parallel fold tips successively arranged in a length extension of the at least one filter bellows transverse to a vertical axis of the at least one filter bellows, wherein the parallel fold tips extend respectively between longitudinal sides of the at least one filter bellows, wherein the longitudinal sides are arranged parallel to the length extension;
a continuous frame, wherein the at least one filter bellows is arranged in the continuous frame so as to be surrounded by the continuous frame;
wherein the continuous frame comprises at least one first frame segment and at least one second frame segment, wherein the at least one first frame segment has a hardness different from a hardness of the at least one second frame segment, wherein the at least one first frame segment is formed of a first hard material and the at least one second frame segment is formed of a second soft material;
wherein the at least one filter bellows is fixed in the at least one second frame segment.

20. The filter system according to claim 19, wherein the at least one filter bellows is fixed in the at least one second frame segment by overmolding at least in sections.
